(19) United States
(12) Patent Application Publication
(10) Pub. No.: US 2010/0014567 A1
(43) Pub. Date: Jan. 21, 2010

(54) AUTOMATIC ADJUSTMENT METHOD FOR SERIAL INTERFACE CIRCUIT AND ELECTRONIC DEVICE HAVING SERIAL INTERFACE CIRCUIT

(75) Inventor: Minoru Yamamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/475,100

(22) Filed: May 29, 2009

(30) Foreign Application Priority Data
Jul. 16, 2008 (JP) 2008-185096

(51) Int. Cl. H04B 1/38

(52) U.S. Cl. 375/220

(57) ABSTRACT

An automatic adjustment method for a serial interface circuit and an electronic device having a serial interface circuit perform automatic adjustment to optimum values of the transmitter, under any connection conditions, and without causing rule violations of the serial interface protocol. Various setting values are used in a transmitter and transmission frame retransmit instructions stipulated by the interface protocol are utilized. The frames are transmitted to a connected device using various setting values, and the results from the connected device (5) are used to adjust to the optimum transmitter values, operation specifications (conditions) of the interface protocol can be satisfied, and through retry of frame transfer the optimum values can be calculated.

### CROSS-REFERENCE TO RELATED APPLICATION

This application is based upon and claims the benefit of priority of the prior Japanese Patent Application No. 2008-185096, filed on Jul. 16, 2008, the entire contents of which are incorporated herein by reference.

### FIELD

The embodiment discussed herein is related to an automatic adjustment method for a serial interface circuit in an electronic device connected to another device by a serial interface and to an electronic device having a serial interface circuit, and in particular relates to an automatic adjustment method for a serial interface circuit and an electronic device having a serial interface circuit to automatically calculate optimum value of the interface signal quality, which is affected by the connection configuration, and to ensure operation.

### RELATED ART

In recent years, serial interfaces have been widely used to connect higher-level devices to peripheral devices. SATA (Serial ATA) and SAS (Serial Attached SCSI) are representative of serial interfaces.

When using such serial interfaces, the signal quality of the serial interface varies greatly, and the transmitter slew rate and similar must be adjusted. For example, in an electronic device of a magnetic disk device, as methods for preventing degradation of signal quality with rising interface transfer rate, various transmitter setting optimization techniques have been proposed (see for example Japanese Patent Application Laid-open No. 2001-119277 and Japanese Patent Application Laid-open No. 11-345054).

However, magnetic disk devices and other electronic devices are connected to host devices in a wide variety of connection modes, and moreover, the optimum settings are first identified after connection with the higher-level device. For example, such configurations include a storage system which is connected numerous magnetic disk devices through a serial interface to a magnetic disk controller, or a server which is connected numerous magnetic disk devices through a serial interface to a plurality of CPUs.

However, on the side supplying the magnetic disk devices or other electronic devices, when incorporating into the system, the transmitter settings are nominal values, and it has not been possible to obtain reliable values.

Hence so-called self-running optimum value computation methods, in which the transmitter optimum values are measured by the magnetic disk device or other electronic device in the state of being connected to another device by a serial interface, have been proposed (see for example Japanese Patent Application Laid-open No. 2000-013283 and Japanese Patent Application Laid-open No. 2005-050257).

In these proposals, a method is disclosed in which training signals or other signals for investigative use are sent to a SATA interface, and transmitter amplitude adjustment is performed using the training signal reception results.

However, because rules of the serial interface have been decided, the serial interface is bound by the constraints of the interface protocol. Hence in a self-running adjustment method of the prior art, examination signals are transmitted over the interface, and the results are repeatedly acquired and processed, so that depending on the serial interface, there is the possibility of violation of existing interface protocol rules.

For this reason, self-running adjustment methods of the prior art cannot be used, and improvement of signal quality through transmitter optimization is difficult. For example, before connection with the higher-level device, each vendor must calculate and set optimum values through independent study/research.

Moreover, even when optimum values are set in this way, when applied in various fields, interface errors frequently occur due to erroneous higher-level device settings or other reasons, and there are cases in which the disk device cannot be recognized. Hence under certain conditions, disk device detachment processing due to signal degradation has occurred.

### SUMMARY

According to an aspect of the embodiment, an automatic adjustment method for a serial interface circuit, to adjust output characteristics of a transmitter which sends signals to a serial interface, including the steps of: sequentially changing output characteristic values of the transmitter, and transmitting a response frame, to which is added information specifying frame resending, to a connected device via the serial interface using the changed output characteristic values by the transmitter; receiving each of reception results to a plurality of the response frames from the connected device via the serial interface; and deciding adjusted values of the output characteristic values of the transmitter from each of the reception results of the response frame.

Also, the present embodiment is for providing an electronic device, including: a serial interface circuit having a transmitter which sends signals to a serial interface; and an adjustment circuit which adjusts output characteristic values of the transmitter, wherein the adjustment circuit sequentially changes the output characteristic values of the transmitter, transmits a response frame, to which is added information specifying frame resending, to a connected device via the serial interface using the changed output characteristic values, receives each of the reception results to a plurality of the response frames from the connected device via the serial interface, and decides adjusted values of the output characteristic values of the transmitter from each of the reception results of the response frame.

Also, in the present embodiment, it is preferable that the transmission step has a step of transmitting the response frame a stipulated number of times, and the step of deciding adjusted values has a step of deciding adjusted values of the output characteristic values of the transmitter based on the stipulated number of times of reception results of the response frame.

Also, in the present embodiment, it is preferable that the transmission step has a first step of sequentially changing the output characteristic values of the transmitter from upper-limit values of an adjustment range and of transmitting the response frame using the changed output characteristic values, and a second step of sequentially changing the output characteristic values of the transmitter from lower-limit values of the adjustment range and of transmitting the response frame using the changed output characteristic values; and the decision step has a step of deciding the adjusted values of the output characteristic values of the transmitter from each of the reception results of the response frame in the first step and from each of the reception results of the response frame in the second step.

Also, in the present embodiment, it is preferable that the decision step has a step of deciding the adjusted values of the output characteristic values of the transmitter from the output characteristic values for the response frame in the last received normal response, among each of the reception results of the response frame in the first step, and from the output characteristic values for the response frame in the last received normal response, among each of the reception results of the response frame in the second step.

Also, in the present embodiment, it is preferable that the transmission step is executed according to a test unit ready command issued from the connected device via the serial interface.

Also, in the present embodiment, it is preferable that the automatic adjustment method further includes a step of storing the decided adjusted values in memory, in association with an address of the connected device.

Also, in the present embodiment, it is preferable that the automatic adjustment method for a serial interface circuit further including the steps of: acquiring an address of the connected device that is connected by the serial interface; judging whether or not the adjusted values of the acquired connected device address are stored in the memory; setting the adjusted values in the transmitter, and transmitting the response frame without adding information specifying resending when it is judged that the adjusted values are stored in the memory; and transmitting the response frame with the resending specified, and performing the automatic adjustment when it is judged that the adjusted values are not stored in the memory.

Also, in the present embodiment, it is preferable that the serial interface is a SAS interface.

Also, in the present embodiment, it is preferable that the output characteristic values of the transmitter include at least one of strength, slew rate, and emphasis.

Also, in the present embodiment, it is preferable that the serial interface circuit is a serial interface circuit to connect a disk device with the connected device.

Because transmission frame retransmit instructions stipulated by the interface protocol are utilized, frames are transmitted using various settings, and the results are used to adjust to the optimum transmitter values, operation specifications (conditions) of the interface protocol can be satisfied, and moreover through retry of frame transfer the optimum values can be calculated.

By this means, detachment processing of a disk device due to signal quality degradation is not performed under any conditions, and device recognition is possible. Further, adjustment of signal quality between devices is possible without adding hardware for automatic adjustment to conventional magnetic disk devices.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of one embodiment of an electronic device;

FIG. 2 is a block diagram of the interface control circuit of FIG. 1;

FIG. 3 explains an automatic adjustment sequence of characteristics of transmitter according to one embodiment;

FIG. 4 explains a sending frame format in FIG. 3;

FIG. 5 explains strength adjustment of the transmitter in FIG. 3;

FIG. 6 explains emphasis adjustment of the transmitter in FIG. 3;

FIG. 7 explains slew rate adjustment of the transmitter in FIG. 3;

FIG. 8 shows a flow of processing of device recognition for execution of automatic measurement processing in one embodiment;

FIG. 9 shows a flow of response processing of FIG. 8;

FIG. 10 shows a flow of automatic adjustment processing for strength in FIG. 9;

FIG. 11 shows a flow of automatic adjustment processing of the emphasis of FIG. 9; and

FIG. 12 explains an adjustment value table of adjustment processing of the emphasis in FIG. 11.

### DESCRIPTION OF THE PREFERRED EMBODIMENTS

Below, embodiments are explained in the order of an electronic device, transmitter adjustment method, and transmitter automatic adjustment processing; however, this invention is not limited to these embodiments.

(Electronic Device)

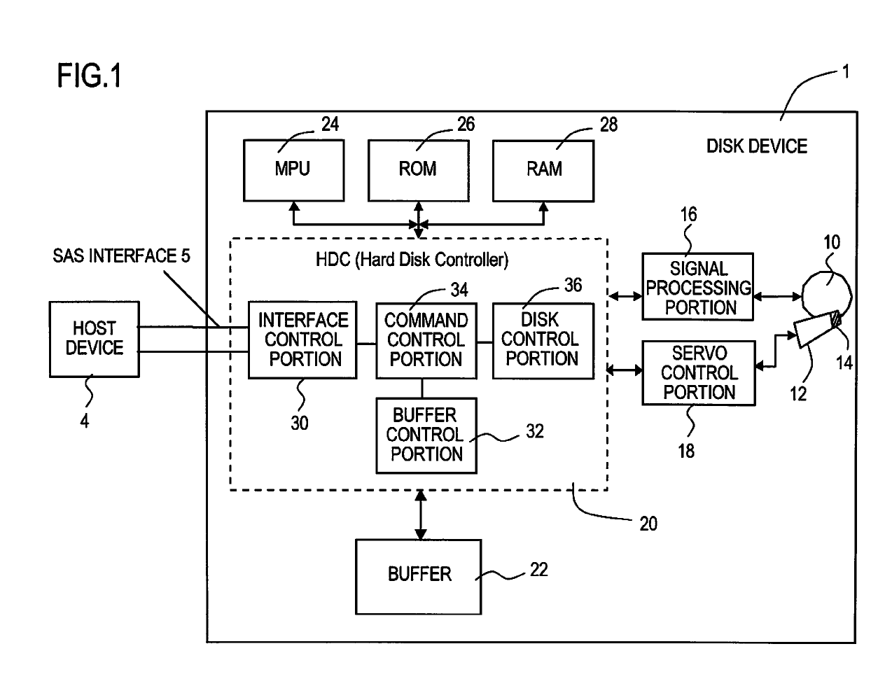

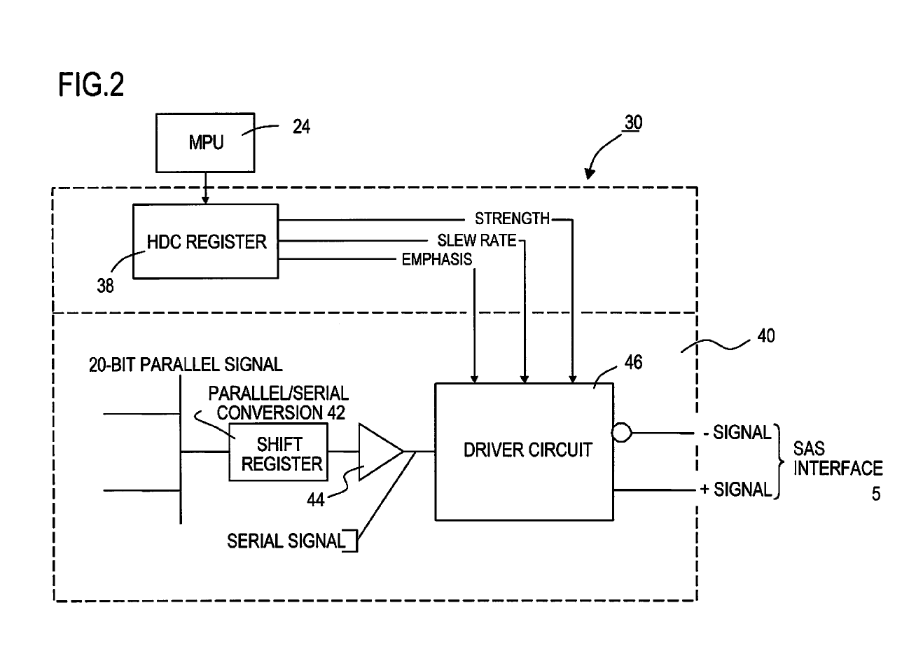

FIG. 1 is a block diagram of an embodiment of an electronic device, and FIG. 2 is a block diagram of the interface control circuit of FIG. 1. FIG. 1 shows a magnetic disk device as an example of an electronic device.

As shown in FIG. 1, the magnetic disk device 1 has a drive mechanism (disk enclosure) and a printed circuit assembly (PCA). In the disk enclosure (called a “DE”), the magnetic disk 10 which is the magnetic recording media is provided on the rotation shaft of a spindle motor (not shown). The spindle motor rotates the magnetic disk 10. The actuator (called a “VCM”) 12 has a magnetic head 14 on the tip of an arm (called a “head actuator”) and suspension, and the magnetic head 14 moves in the radial direction of the magnetic disk 10.

The actuator 12 has a voice coil motor (VCM) which rotates about a rotation shaft. The magnetic head 14 has a read element and a write element.

On the printed circuit assembly (control circuit portion) are provided a hard disk controller (HDC) 20, microprocessor (MPU) 24, signal processing circuit (read channel circuit, RDC) 16, servo-controller circuit 18, data buffer (RAM) 22, ROM (Read-Only Memory) 26, and RAM 28.

The read channel circuit (RDC) 16 has a pre-amp, and controls data reading and writing by the magnetic head 14. That is, data modulation, data demodulation, and signal amplification are performed. The servo-controller circuit (SVC) 18 drives and controls the spindle motor, and drives and controls the VCM 12.

The hard disk controller (HDC) 20 has an interface control circuit 30 which performs interface control, a command control circuit 34 which performs control according to commands from a higher level, a data buffer control circuit 32 which controls the data buffer 22, and a disk control circuit 36 which performs disk format control and similar. The data buffer (RAM) 22 temporarily stores read data and write data.

The microprocessor (MPU) 24 controls the HDC 36 and manages the RAM 28 and ROM 26. The ROM 26 stores various programs and parameters. The RAM 28 stores various data required for processing by the MPU 24.

As shown in FIG. 1, the interface control circuit 30 is connected to the host device 4 by a SAS (Serial Attached SCSI) interface 5. Hence the interface control circuit 30 has a SAS interface control circuit.

FIG. 2 is a block diagram of the transmitter (transmission circuit) of the SAS interface control circuit 30. The transmitter 40 has a parallel/serial converter 42, which converts 20-bit parallel transmission data into serial signals, a buffer amp 44 which amplifies serial signals, and a driver circuit 46 which generates signals for the two-line (+, −) SAS interface 5 from the serial signals from the buffer amp 44.

This driver circuit 46 is a well-known driver circuit, having an amplifier and a resistor for adjustment; the maximum amplitude (strength), slew rate (rate of change of signal voltage), and emphasis (transmission path impedance) can be changed through the resistance value and other settings. The parallel/serial converter 42 has a shift register.

The HDC register 38 provided within the HDC 20 is set each setting values for the maximum amplitude (strength), slew rate (rate of change of signal voltage), and emphasis (transmission path impedance) of the driver circuit 46 by the MPU 24. And, the driver circuit 46 output serial signals to the SAS interface 5 according to the values of the maximum amplitude (strength), slew rate (rate of change of signal voltage), and emphasis (transmission path impedance) set in the HDC register 38.

(Transmitter Adjustment Method)

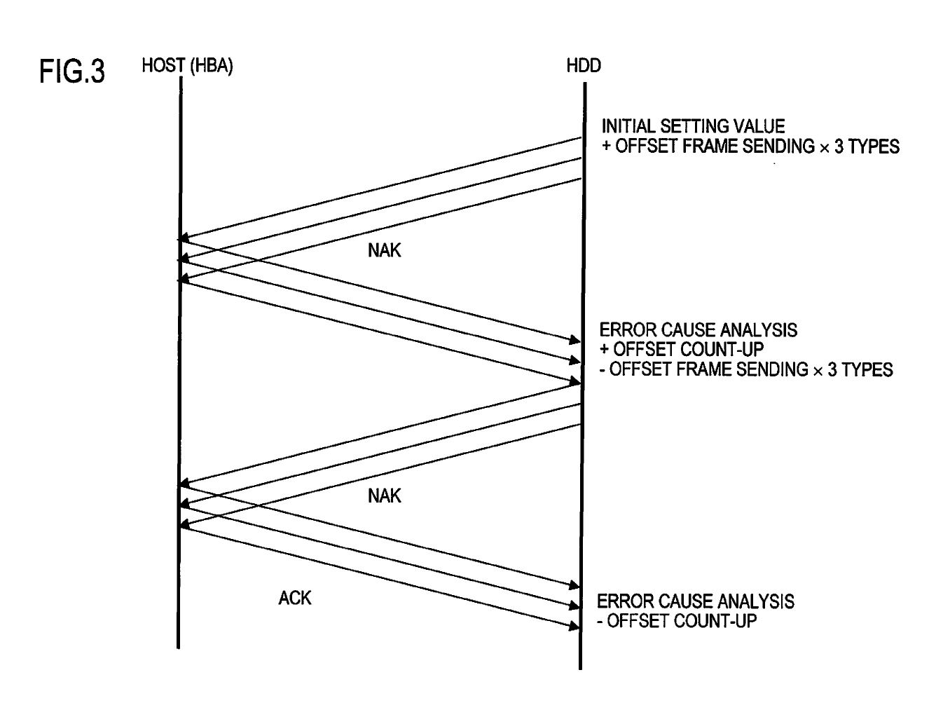

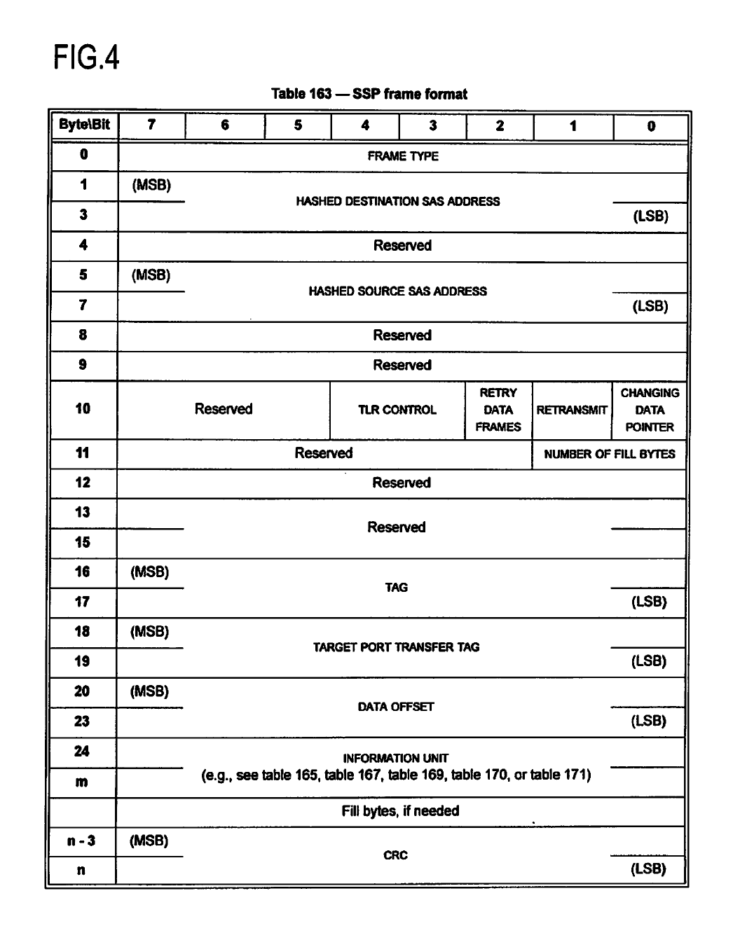

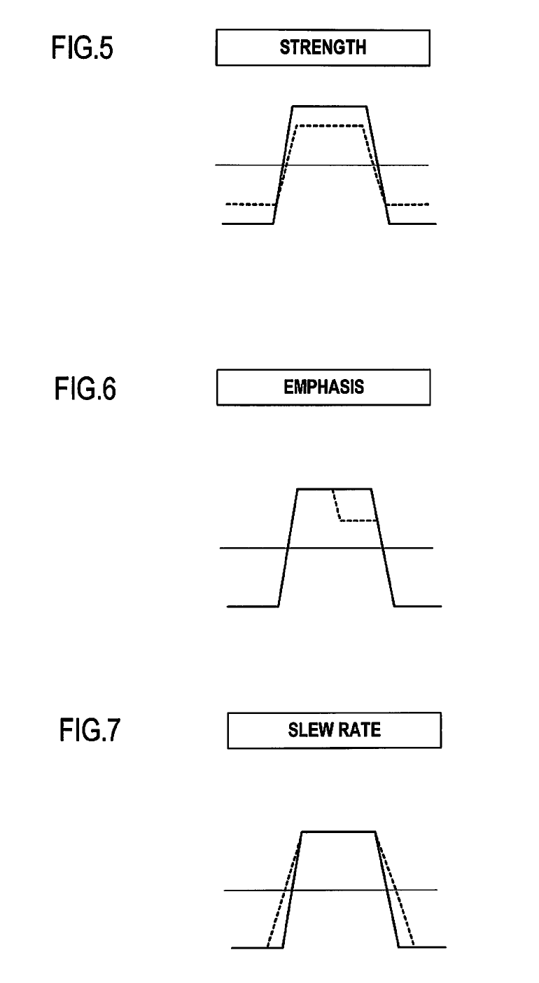

FIG. 3 explains the automatic adjustment sequence of an embodiment, FIG. 4 explains an SSP frame in FIG. 3, FIG. 5 explains the maximum amplitude (strength) in FIG. 3, FIG. 6 explains the emphasis (transmission path impedance) in FIG. 3, and FIG. 7 explains the slew rate (rate of change of signal voltage) in FIG. 3.

FIG. 3 and FIG. 4 take as examples a SAS (Serial Attached SCSI) interface in order for a magnetic disk device to perform self-running optimum value calculations. FIG. 4 explains the SSP (Serial SCSI Protocol) frame format, for frames transmitted and received in the SSP transport layer positioned below the SAS physical layer and link layer.

As shown in FIG. 4, an SSP frame is a frame which specifies one among DATA, XFER RDY, COMMAND, RESPONSE, or TASK. The frame type is set in the 0th byte of the SSP frame, the destination SAS address is set in the first through third bytes, and the source SAS address is set in the fifth through seventh bytes.

A retransmit bit is provided in the first bit of the tenth byte. The retransmit bit is used as a bit to indicate that the magnetic disk device is resending the frame, due to detection of an error in the frame on the magnetic disk device side at the time of response frame transmission.

Also, in the SAS interface protocol, there is no stipulation of the time or number of resending of a response frame in which this bit has been set. That is, the same frame can be transmitted any number of times, so long as the time or the number of resending specified on the magnetic disk device side is not exceeded. The SAS interface can be utilized in this way to perform automatic adjustment, without deviating from the protocol rules.

To this end, in this embodiment, even when it is possible that the magnetic disk device sends normal response, the magnetic disk device changes the signal setting values to various values and transmits responses using response frames in which the settable retransmit bit has been set, obtains the reception results from the transmission destination, and optimizes the signal setting values.

Further, even when a response from the transmission destination to a response frame transmitted from the magnetic disk device is a normal response (ACK), the ACK is regarded as having disappeared, the adjustment task is continued, upper-limit and lower-limit values are measured, and optimum settings are calculated.

Transmitter items for adjustment are the following three items. And initially frame transmission is attempted with each at values which are offset in the plus/minus direction from initial settings, errors are intentionally generated, and by comparing the numbers of errors, the error states, and the offset values, the upper/lower limits for each setting are calculated, and the values are referenced to perform self-adjustment.

(1) As shown in FIG. 5, the strength (maximum amplitude) is the maximum amplitude of signals output by the driver circuit 46; the maximum amplitude is changed as indicated by the solid line with respect to the dashed-line maximum amplitude, and the optimum value is measured.

(2) As shown in FIG. 7, the slew rate (rate of change of voltage) is the extent of the rising or falling slope of the signal (voltage) from the driver circuit 46; the optimum value is adjusted to the voltage change rate of the dashed line and the voltage change rate of the solid line.

(3) As shown in FIG. 6, the emphasis (transmission path impedance) is used in distortion compensation performed by the driver circuit 46 before transmission, because distortion occurs in the transmission waveform shape upon passing through the transmission path.

These calculated setting values are saved in nonvolatile memory (for example, the RAM 28 or disk media 10 of FIG. 1). When power is again turned on, the saved data is read, and when the environment is the same, the automatic adjustment task is not repeated.

On the other hand, even when saved data exists, if the environment is not the same, measurement processing is similarly performed.

FIG. 3 is used to explain the exchange of response frames between devices. In FIG. 3, the HDD (magnetic disk device) and the host device (host bus adapter, HBA) are connected by a SAS interface.

This adjustment is performed only for commands in a magnetic disk recognition sequence. Command processing in a magnetic disk recognition sequence is performed after power has been turned on, before actual reading/writing of the disk media before the spindle motor has reached steady-state rotation. The test unit ready command is taken as an example of a command.

As shown in FIG. 3, when the HDD performs response frame transmission for this command, the transmitter setting values (the setting values in the HDD register 38 of FIG. 2) explained in FIG. 5 through FIG. 7 are changed for each adjustment item in FIG. 5 through FIG. 7, and transmission to the higher-level host is performed. In FIG. 3, three response frames are transmitted. The adjustment items for the three response frames are the strength, slew rate, and emphasis; each is initially offset in the plus/minus direction from initial value settings, and frames with the above-described retransmit bit turned on are transmitted to the host.

The host receives each of these response frames, and responds to the HDD with an ACK response (received normally) or with a NAK (could not be received normally). Even when the host responds with ACK, the HDD performs adjustment processing, incrementing an ACK/NAK counter to a stipulated number of times, and finally receives an ACK response and temporarily saves the settings.

When, for a response frame, there is a NAK response or an ACK/NAK timeout (abnormality), an internal abnormality detection counter is incremented, and even when there is an ACK response (normal), until the stipulated number of tests is reached the retransmit bit is set as if NAK were received, and response frame transmission is continued.

The results of performing automatic adjustment are stored as characteristic data of the WWN (World Wide Name) of the connected device in nonvolatile memory, and when the power is again turned on, the saved data is read and set. As the storage format, for a SAS Hashed WWN (2 DWORD), a plurality of register settings are stored, and the target connected device address is a finite value (for example, 64).

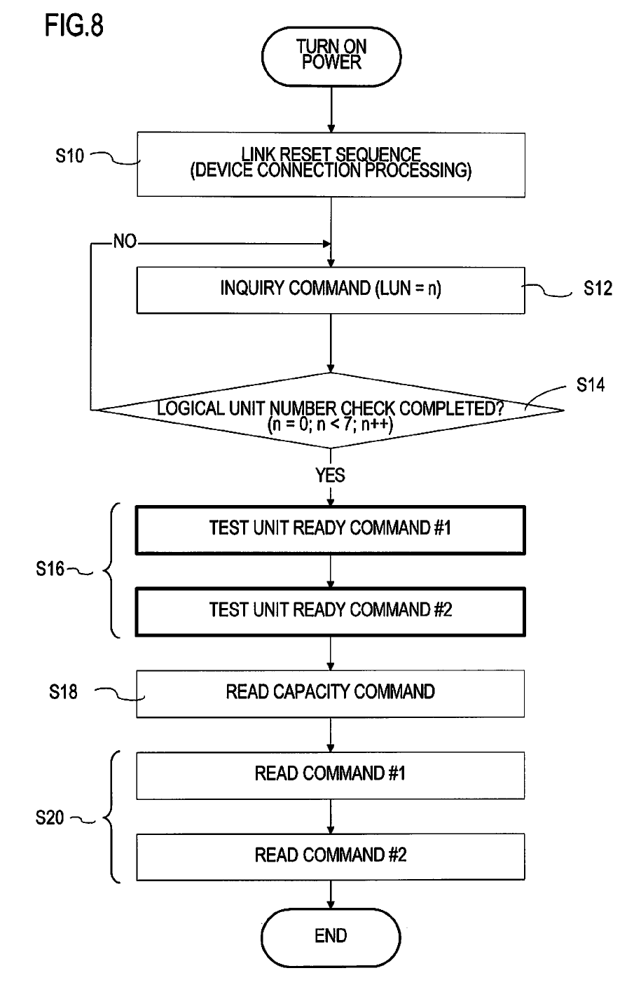

The details of this processing are explained by FIG. 8 through FIG. 11 below.

In this way, a transmission frame retransmit instruction stipulated in the interface protocol is used to transmit frames with various settings, and the results are used to adjust the transmitter optimum values, so that operation specifications (conditions) of the interface protocol can be satisfied, and by retrying frame transfer, optimum values can be calculated.

By this means, disk device detachment processing due to signal quality degradation is not performed under any conditions, and device recognition is possible. Further, signal quality between devices can be adjusted without adding any hardware for automatic adjustment to conventional magnetic disk devices.

(Transmitter Automatic Adjustment Processing)

FIG. 8 shows the flow of processing of SCSI device recognition for execution of automatic measurement processing in an embodiment. A command sequence issued by the host to the magnetic disk device is shown.

(S10) After power is turned on, the host (SCSI higher-level device) executes a link reset sequence for device connection processing.

(S12) The host issues an INQUIRY command to the device with LUN (Logical Unit Number)=n, via the SAS interface.

(S14) The host recognizes the response from the device, and judges whether the LUN check has been completed.

If the check is judged not to be completed, LUN=n is incremented by 1, and processing returns to step S12.

(S16) Upon LUN check completion for all connected devices, the host judges that the configuration has been confirmed. And, a test unit ready command is issued to each device. By means of this command, each connected device executes a unit test and responds to the host. In this embodiment, the automatic adjustment explained using FIG. 3 and other figures is executed in the response transmissions to this command.

(S18) The host executes a read capacity command to connected devices, inquiring about device capacity. In response, the connected devices respond to the host, reporting capacities.

(S20) The host issues a read command to connected devices, inquiring about the leading LBA (Logical Block Address). In response, a connected device responds to the host, reporting the leading LBA. By this means, the host recognizes the connected device capacity and logical space from the LBA. Then, device recognition processing ends.

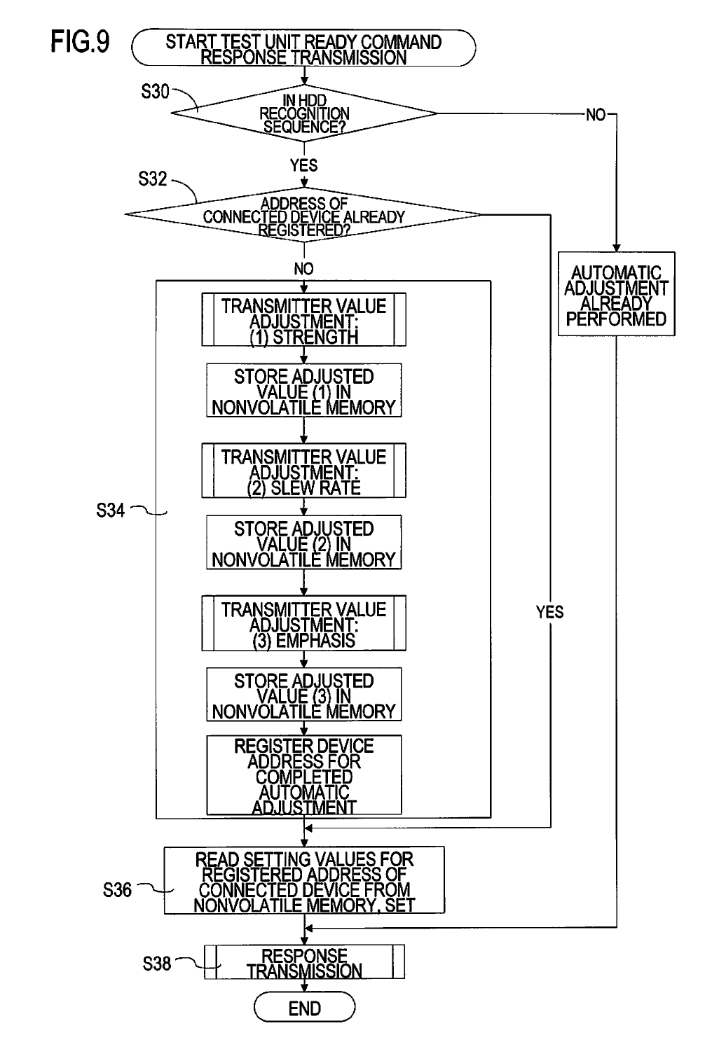

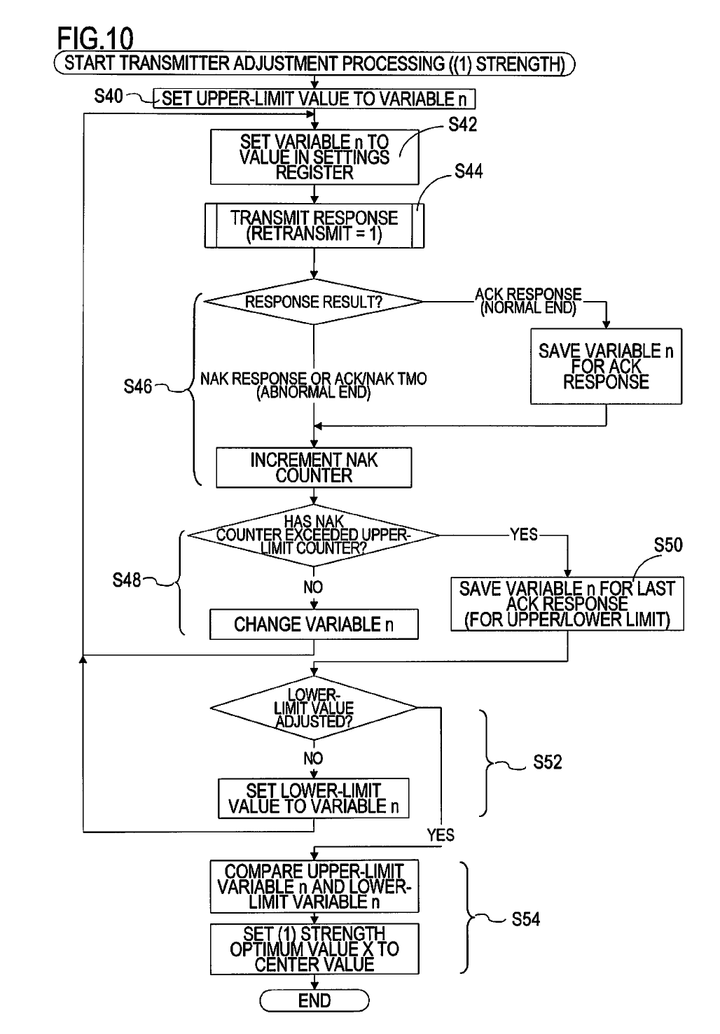

FIG. 9 shows the flow of response processing on the device side to the test unit ready command of FIG. 8. The following processing is performed by the MPU 24 of the HDD 1.

(S30) When the MPU 24 of the HDD 1 receives a notification of reception of the test unit ready command from the command control circuit 34 of the HDC 20, the MPU 24 of the HDD 1 judges whether or not the above-described device recognition sequence is being performed. When the test unit ready command is not part of a device recognition sequence, automatic adjustment has already been performed, and so processing advances to the response transmission of step S38.

(S32) The MPU 24 investigates whether or not the connected device address has already been registered in RAM 28. If the connected device address has already been registered, automatic adjustment has already been performed, and so processing advances to the read processing of step S36.

(S34) When the connected device address has not already been registered, automatic adjustment has not been performed, and so the MPU 24 performs the transmitter value adjustment processing explained in FIG. 10 through FIG. 12, and stores the respective adjusted values (strength, slew rate, emphasis) in nonvolatile memory (RAM) 28. After storage, the connected device address is associated with the adjusted values and stored in nonvolatile memory (RAM) 28.

(S36) The MPU 24 reads the setting values for the registered connected device address from RAM 28, sets the values in the HDD register 38, and sets the characteristics of the driver circuit 46 to the setting values.

(S38) The MPU 24 response to the host (connected device) with a normal response by means of the interface control circuit 30 of the HDC 20. Processing of the test unit ready command then ends.

FIG. 10 shows the flow of automatic adjustment processing for strength in FIG. 9.

(S40) The MPU 24 sets the upper-limit value for the strength to the variable n.

(S42) The MPU 24 sets the variable n to the strength in the HDD register 38.

(S44) The MPU 24 creates the response frame of FIG. 4, sets the retransmit bit to “1”, and transmits the response from the driver circuit 46.

(S46) The MPU 24 receives, from the driver circuit 46, a response from the connected device (host) which has received the transmitted response, and judges whether the response is an ACK response, a NAK response, or an ACK/NAK response TMO (time-out). Upon judging that an ACK response (normal end) has been received, the MPU 24 saves the variable n at the time of reception of the ACK response. Upon judging that a response is an ACK response, a NAK response (abnormal end), or an ACK/NAK response time-out, the MPU 24 increments the NAK counter. Hence the NAK counter counts the number of response transmissions.

(S48) The MPU 24 judges whether or not the NAK counter value (number of response transmissions) has exceeded the upper-limit counter value. Upon judging that the NAK counter value has not exceeded the upper-limit counter value, the MPU 24 changes the variable n. When the upper-limit value is taken as the initial value, the variable n is changed to a value smaller than the upper-limit value, and when the lower-limit value is taken as the initial value, the variable n is changed to a value larger than the lower-limit value. Then, processing returns to step S42.

(S50) If on the other hand the MPU 24 judges that the NAK counter value has exceeded the upper-limit count value, the stipulated number of response transmissions has ended, and so among the variable saved in step S46, the variable (strength setting value) at the time of reception of the final ACK response is saved. This variable (strength setting value) at the time of the final reception of the ACK response is the ACK response upper-limit value when taking the upper-limit value as the initial value, and is the ACK response lower-limit value when taking the lower-limit value as the initial value.

(S52) The MPU 24 judges whether or not lower-limit value adjustment has ended. If lower-limit value adjustment has not ended, the MPU 24 sets the strength lower-limit value to the variable n, and processing returns to step 42.

(S54) Upon judging that lower-limit value adjustment has ended, the MPU 24 compares the ACK response upper-limit variable n obtained in step S50 with the lower-limit variable n, and sets the strength optimum value X to the center value between the ACK response upper-limit variable n and lower-limit variable n. By this means, strength adjustment is ended.

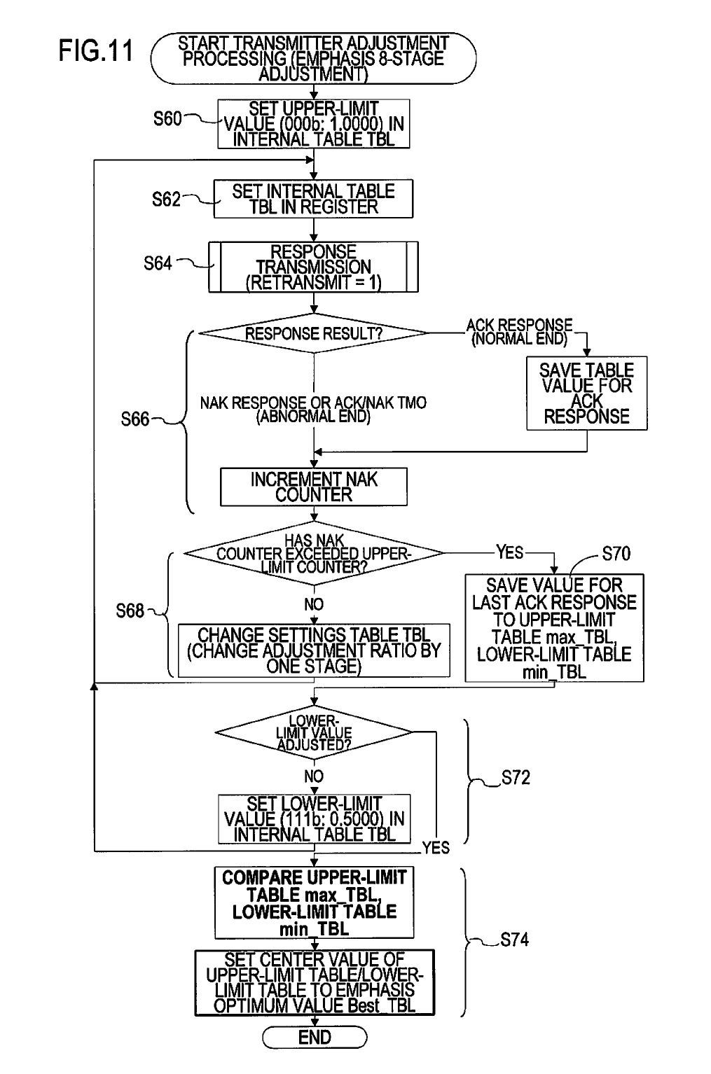

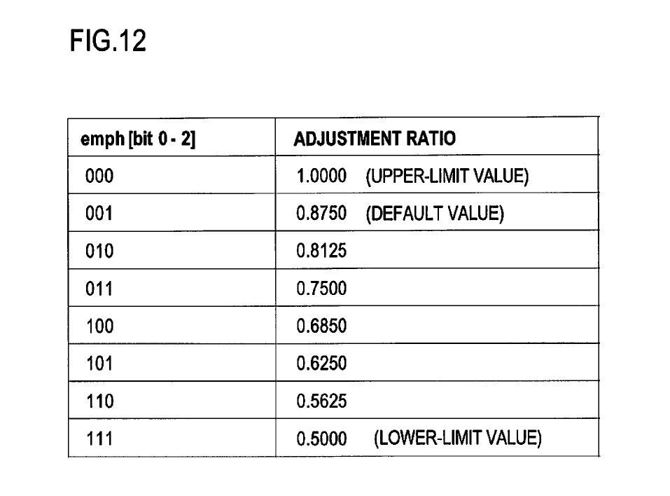

Next, emphasis adjustment is explained. FIG. 11 shows the flow of automatic adjustment processing of the emphasis of FIG. 9, and FIG. 12 explains the adjustment value table. First, as shown in FIG. 12, a table of adjustment values and adjustment ratios is prepared in RAM 28. Here, an example is shown of eight adjustment stages, from the upper-limit adjustment ratio of 1.00 to the lower-limit adjustment ratio of 0.500.

(S60) The MPU 24 sets the emphasis upper-limit value in the internal table TBL.

(S62) The MPU 24 sets the internal table TBL in the emphasis of the HDD register 38.

(S64) The MPU 24 creates the response form of FIG. 4, sets the retransmit bit to “1”, and transmits the response from the driver circuit 46.

(S66) The MPU 24 receives, from the driver circuit 46, a response from the connected device (host) which has received the transmitted response, and judges whether the response is an ACK response, a NAK response, or an ACK/NAK response TMO (time-out). Upon judging that the response is an ACK response (normal end), the MPU 24 saves the table value TBL at the time of reception of the ACK response. Upon judging that an ACK response or a NACK response (abnormal end) has been received, or that there has been an ACK/NAK response time-out, the MPU 24 increments the NAK counter. Hence the NAK counter counts the number of response transmissions.

(S68) The MPU 24 judges whether or not the NAK counter value (number of response transmissions) has exceeded the upper-limit count value. Upon judging that the NAK counter value has not exceeded the upper-limit count value, the MPU 24 changes the settings table TBL, and changes the adjustment ratio by one stage. When taking the upper-limit value as the initial value, the value is changed to a smaller value than the upper-limit value, and when taking the lower-limit value as the initial value, the value is changed to a larger value than the lower-limit value. Then, processing returns to step S62.

(S70) On the other hand, upon judging that the NAK counter value has exceeded the upper-limit count value, because the stipulated number of response transmissions has ended, the MPU 24 saves the table value (emphasis setting value) at the time of the last reception of an ACK response among the table values saved in step S66. The table value at the time of the last reception of an ACK response (the emphasis setting value) is the ACK response upper-limit value max TBL when the upper-limit value is the initial value, and is the ACK response lower-limit value min TBL when the lower-limit value is the initial value.

(S72) The MPU 24 judges whether or not lower-limit value adjustment has ended. If lower-limit value adjustment has not ended, the MPU 24 sets the emphasis lower-limit value in the internal table TBL, and processing returns to step S62.

(S74) When it is judged that lower-limit value adjustment has ended, the MPU 24 compares the ACK response upper-limit table value max TBL and the lower-limit table value min TBL obtained in step S70, and sets the emphasis optimum value Best TBL to the center value between the ACK response upper-limit table value max TBL and the lower-limit table value min TBL. By this means, emphasis adjustment is ended.

Processing for automatic adjustment of the slew rate is the same as processing for automatic adjustment of the emphasis in FIG. 11, and an explanation is omitted.

In the prior art, prior to connection to a higher-level device, optimum values and been calculated/set by each vendor through independent study/research, and so upon application in various fields, or due to erroneous higher-level device settings or similar, interface errors frequently occurred, and there have been cases in which disk devices cannot be recognized.

In this embodiment, a transmission frame resend instruction stipulated in the interface protocol is utilized to transmit frames with various setting values, and the results are used to adjust to the transmitter optimum values, so that the interface protocol operation specifications (conditions) can be satisfied, and by retrying frame transfer, optimum values can be calculated.

By this means, disk device detachment processing due to signal quality degradation is not performed under any conditions, and device recognition is possible. Further, adjustment of signal quality between devices is possible without adding hardware for automatic adjustment to conventional magnetic disk devices.

### Other Embodiments

In the above-described embodiment, a magnetic disk device was used as an example of an electronic device in the explanation; but application to other devices connected to a serial interface (for example, optical disc devices and other media storage devices, communication devices, display devices, printers, and similar) is also possible. In addition, an SAS interface was assumed as the serial interface in explanations; but application to other serial interfaces having a frame format which supports resend instructions is also possible.

Further, the transmitter strength, slew rate, and emphasis were assumed as quantities for adjustment; but at least any one of these may be adjusted.

In the above, embodiments have been explained, but this invention can be various modified within the gist thereof, and such modifications are not excluded from the scope of the invention.

Because transmission frame retransmit instructions stipulated by the interface protocol are utilized, frames are transmitted using various settings, and the results are used to adjust to the optimum transmitter values, operation specifications (conditions) of the interface protocol can be satisfied, and moreover through retry of frame transfer the optimum values can be calculated.

By this means, detachment processing of a disk device due to signal quality degradation is not performed under any conditions, and device recognition is possible. Further, adjustment of signal quality between devices is possible without adding hardware for automatic adjustment to conventional magnetic disk devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. An automatic adjustment method for a serial interface circuit, to adjust output characteristics of a transmitter which sends signals to a serial interface, comprising the steps of:
transmitting each response frame, to which is added information specifying frame resending, to a connected device via the serial interface by the transmitter which is set the sequentially changed output characteristic values;
receiving each of reception results to a plurality of the response frames from the connected device via the serial interface; and
deciding adjusted values of the output characteristic values of the transmitter from said changed output characteristic values and each of the reception results of the response frame.

2. The automatic adjustment method for a serial interface circuit according to claim 1, wherein the transmission step comprises a step of transmitting the response frame a stipulated number of times, and
the step of deciding adjusted values comprises a step of deciding adjusted values of the output characteristic values of the transmitter based on the stipulated number of times of reception results of the response frame.

3. The automatic adjustment method for a serial interface circuit according to claim 1, wherein the transmission step comprises:
a first step of sequentially changing the output characteristic values of the transmitter from upper-limit values of an adjustment range and of transmitting the response frame using the changed output characteristic values; and
a second step of sequentially changing the output characteristic values of the transmitter from lower-limit values of the adjustment range and of transmitting the response frame using the changed output characteristic values;
and wherein the decision step comprises a step of deciding the adjusted values of the output characteristic values of the transmitter from each of the reception results of the response frame in the first step and from each of the reception results of the response frame in the second step.

4. The automatic adjustment method for a serial interface circuit according to claim 3, wherein the decision step comprises a step of deciding the adjusted values of the output characteristic values of the transmitter from the output characteristic values for the response frame in the last received normal response, among each of the reception results of the response frame in the first step, and from the output characteristic values for the response frame in the last received normal response, among each of the reception results of the response frame in the second step.

5. The automatic adjustment method for a serial interface circuit according to claim 1, wherein the transmission step is executed according to a test unit command issued from the connected device via the serial interface.

6. The automatic adjustment method for a serial interface circuit according to claim 1, further comprising a step of storing the decided adjusted values in memory, in association with an address of the connected device.

7. The automatic adjustment method for a serial interface circuit according to claim 1, further comprising the steps of:
acquiring an address of the connected device that is connected by the serial interface;
judging whether or not the adjusted values of the acquired connected device address are stored in a memory;
setting the adjusted values in the transmitter, and transmitting the response frame without adding information specifying resending when it is judged that the adjusted values are stored in the memory; and
transmitting the response frame with the resending specified, and performing the automatic adjustment when it is judged that the adjusted values are not stored in the memory.

8. The automatic adjustment method for a serial interface circuit according to claim 1, wherein the serial interface is a SAS interface.

9. The automatic adjustment method for a serial interface circuit according to claim 1, wherein the output characteristic values of the transmitter comprise at least one of strength, slew rate, and emphasis.

10. The automatic adjustment method for a serial interface circuit according to claim 1, wherein the serial interface circuit is a serial interface circuit to connect a disk device with the connected device.

11. An electronic device having a serial interface circuit, comprising:
a serial interface circuit having a transmitter which sends signals to a serial interface; and
an adjustment circuit which adjusts output characteristic values of the transmitter,
wherein the adjustment circuit sequentially changes the output characteristic values of the transmitter, transmits a response frame, to which is added information specifying frame resending, to a connected device via the serial interface using the changed output characteristic values, receives each of the reception results to a plurality of the response frames from the connected device via the serial interface, and decides adjusted values of the output characteristic values of the transmitter from each of the reception results of the response frame and the changed output characteristic values.

12. The electronic device having a serial interface circuit according to claim 11, wherein the adjustment circuit transmits the response frame a stipulated number of times, and decides adjusted values of the output characteristic values of the transmitter based on the stipulated number of times of reception results of the response frame.

13. The electronic device having a serial interface circuit according to claim 11, wherein the adjustment circuit executes a first measurement mode of sequentially changing the output characteristic values of the transmitter from upper-limit values of an adjustment range and of transmitting the response frame using the changed output characteristic values, and a second measurement mode of sequentially changing the output characteristic values of the transmitter from lower-limit values of the adjustment range and of transmitting the response frame using the changed output characteristic values, and decides the adjusted values of the output characteristic values of the transmitter from each of the reception results of the response frame in the first measurement mode and from each of the reception results of the response frame in the second measurement mode.

14. The electronic device having a serial interface circuit according to claim 13, wherein the adjustment circuit decides the adjusted values of the output characteristic values of the transmitter from the output characteristic values for the response frame in the last received normal response, among each of the reception results of the response frame in the first measurement mode, and from the output characteristic values for the response frame in the last received normal response, among each of the reception results of the response frame in the second measurement mode.

15. The electronic device having a serial interface circuit according to claim 11, wherein the adjustment circuit executes automatic adjustment processing according to a test unit command issued from the connected device via the serial interface.

16. The electronic device having a serial interface circuit according to claim 11, wherein the adjustment circuit stores the decided adjusted values in a memory, in association with an address of the connected device.

17. The electronic device having a serial interface circuit according to claim 11, wherein the adjustment circuit acquires an address of the connected device that is connected by the serial interface, judges whether the adjusted values of the acquired connected device address are stored in the memory, sets the adjusted values in the transmitter and transmits the response frame without adding information specifying resending when it is judged that the adjusted values are stored in the memory, and transmits the response frame with the resending specified and performs the automatic adjustment when it is judged that the adjusted values are not stored in the memory.

18. The electronic device having a serial interface circuit according to claim 11, wherein the serial interface is a SAS interface.

19. The electronic device having a serial interface circuit according to claim 11, wherein the output characteristic values of the transmitter comprise at least one of strength, slew rate, and emphasis.

20. The electronic device having a serial interface circuit according to claim 11, wherein the serial interface circuit and the adjustment circuit are incorporated in a disk device.
